(19) United States
(12) Patent Application Publication
(10) Pub. No.: US 2005/0193710 A1
(43) Pub. Date: Sep. 8, 2005

(54) Rake assembly with pickup function

(76) Inventor: Shuei-Lin Shen, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/794,834

(22) Filed: Mar. 3, 2004

(51) Int. Cl. A01D 7/00

(52) U.S. Cl. 56/400.12

(57) ABSTRACT

A rake assembly with pickup function comprises a handle rod having an end connected to a rake plate; a two-piece pivotal link rod with one end connected to a clamping plate, and the handle rod passes through the space between the two pivotal link rods at a position proximate to the body of the rake plate, a pair of link plates with both ends pivotally coupled to the handle rod and the body of the pivotal rods; a pushing rod being parallel to the handle rod and shifted along the body of the handle rod, and the bottom of the pushing rod is connected to the link rods. By the foregoing structure, users can push or pull the pushing rod along the handle rod to drive the pivotal link rod and the handle rod for alternate pivotal movements and thus producing a clamping movement or a releasing movement between the rake plate and the clamping plate.

### FIELD OF THE INVENTION

The present invention relates to a rake assembly, more particularly to a rake capable of raking grasses, leaves, and light debris into a pile, and picking them up.

### BACKGROUND OF THE INVENTION

In gardening and horticulture, cut and trimmed branches with a larger size can be picked up easily by hands, but grasses and leaves with a smaller size are usually raked into a pile, and then picked up for disposal. In general, the tool used for raking grasses and leaves is a rake, and the tool for picking up grasses and leaves for disposal is a basket, a broom, or hands. However, it is necessary to change tools to rake and pick up the debris for disposal, and the whole process is not a single continuous action, and thus affecting the working efficiency and also wasting user's physical strength.

### SUMMARY OF THE INVENTION

The primary objective of the present invention is to provide a rake assembly with pickup function, and such rake can rake grass and leaf debris into a pile and then pick them up for disposal. The whole process takes place in a single continuous action, so that the gardener no longer needs to change tools frequently for cleaning up the grass and leaf debris, and thus improving the working efficiency and saving physical strength.

Another objective of the present invention is to provide a rake assembly with pickup function, and such rack has a foldable handle rod which reduces the volume and cost for packaging and transportation.

### BRIEF DESCRIPTION OF THE DRAWINGS

FIG. 1 is an exploded view of the rake assembly according to a first preferred embodiment of the present invention.

FIG. 2 is a perspective view of the rake assembly according to a first preferred embodiment of the present invention.

FIG. 3 is a view of the movements of the rake according to a first preferred embodiment of the present invention.

FIG. 4 is a view of the rake picking up the grass and leaf debris according to a first preferred embodiment of the present invention.

FIG. 5 is another view of the rake picking up the grass and leaf debris according to a first preferred embodiment of the present invention.

FIG. 6 is a sectional view of the section 6-6 as depicted in FIG. 2.

FIG. 7 is a perspective view of the rake assembly according to a second preferred embodiment of the present invention.

FIG. 8 is an external look of the rake assembly according to a second preferred embodiment of the present invention.

FIG. 9 is an illustrative planar view of the rake assembly being disassembled for packing according to a second preferred embodiment of the present invention.

### DETAILED DESCRIPTION OF THE PREFERRED EMBODIMENTS

A rake assembly with pickup function according to the present invention comprises:

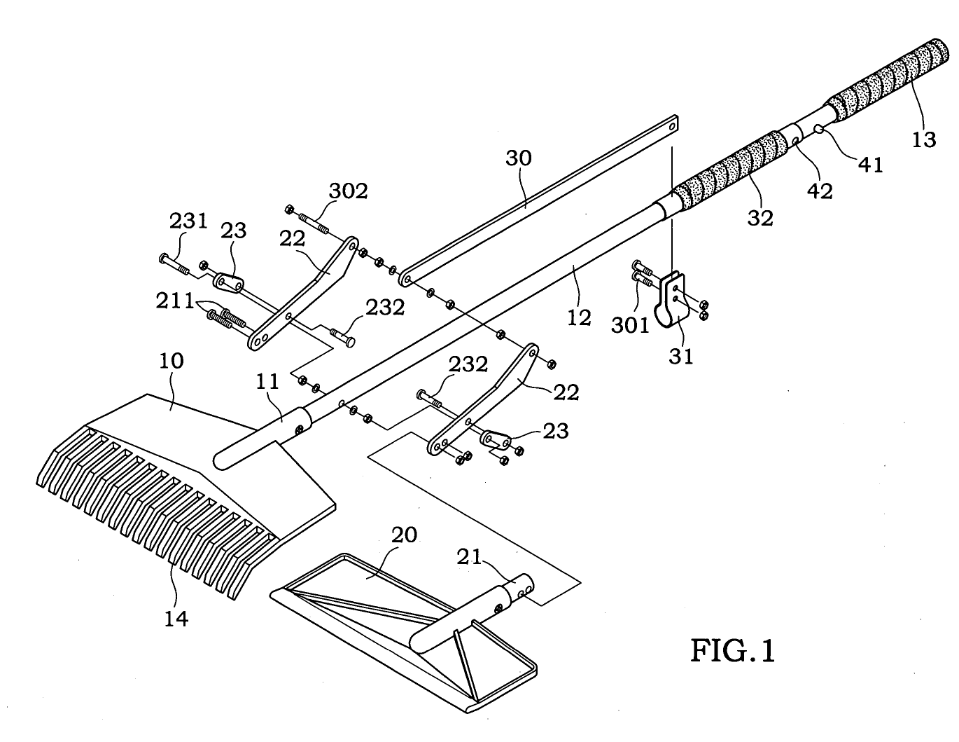

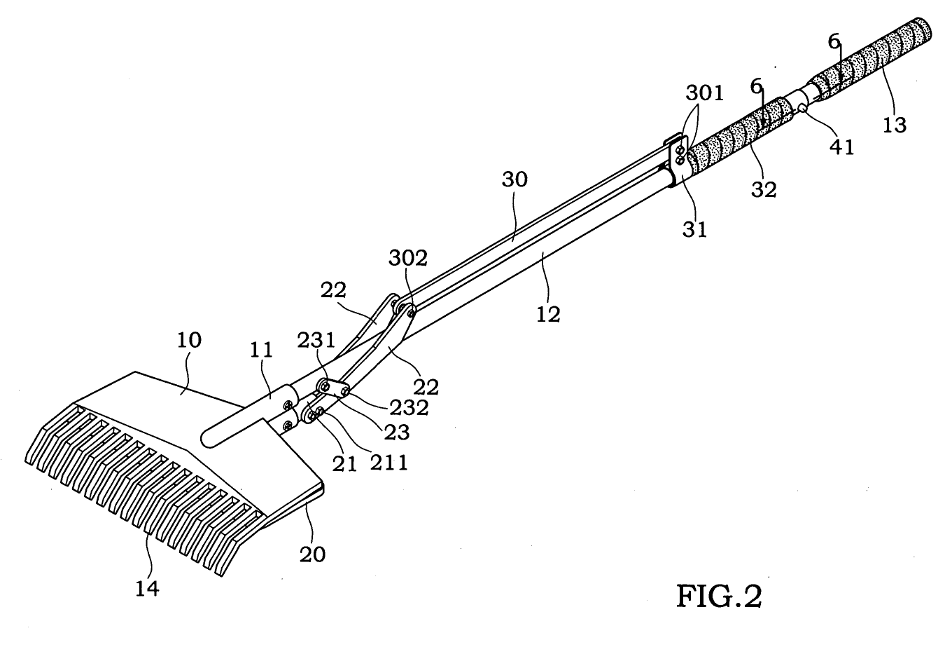

a rake plate 10, as shown in FIGS. 1 and 2, having a plurality of tines 14 at one end, a casing pipe 11 at the middle of another end for connecting a handle rod 12, and a handle 13 wrapped with a soft elastic tape disposed at another end of the handle rod 12;

a clamping plate 20, as shown in FIGS. 1 and 2, being a plate member and having a casing pipe 21 disposed at the middle of one end, and two pivotal link rods 22 being installed by a screw member 211 onto the corresponding outer sides of the casing pipe 21 such that the handle rod 12 is disposed between the two pivotal link rods 22, and the two link plates with both ends pivotally connected to the handle rod 12 and the pivotal link rods 22 by a pivotal member 231, 232 respectively, thereby the handle rod 12 and the pivotal link rods 22 use the link plates 23 as the pivotal center for the alternate opening and closing movements;

a pushing rod 30, as shown in FIGS. 1 and 2, having one end pivotally coupled to a buckle ring 31 by a pivotal member 301, and the buckle ring 31 being mounted onto a sliding sheath 32 which is sheathed onto the handle rod 12, and the sliding sheath 32 is wrapped with a soft elastic tape, and the other end of the pushing rod 30 being movably installed between two pivotal link rods 22 by a pivotal member 302, thereby when a user pushes the sliding sheath 32, the pushing rod 30 moves accordingly.

A sliding sheath and pushing rod fixture assembly 40 as shown in FIGS. 1, 2, and 6, comprises a spring pip 41 embedded inside the rod body of the handle rod 12 at the position proximate to the handle 13, and a pip hole 42 disposed at the top of the sliding sheath 32. If the sliding sheath 32 is pushed to the top of the handle rod 12, the pip hole 42 for snapping in the spring pip 41 will fix the sliding sheath 32, and will in turn set the pushing rod in a fixed position since the sliding sheath 32 is connected to an end of the pushing rod 30. On the other hand, if the spring pip 41 is pressed by a finger, and the sliding sheath 32 is pushed in the direction away from the handle 13 by another hand, the spring pip 41 will be detached from the pip hole 42 releasing the fixed positions of the pushing rod 30 and the sliding sheath 32. The sliding sheath 32 driven by the user's push or pull will move the pushing rod 30 along the handle rod 12, and will further drive the pivotal link rods 22 and the handle rod 12 to move alternately and the clamping plate 20 will produce the clamping and releasing movements.

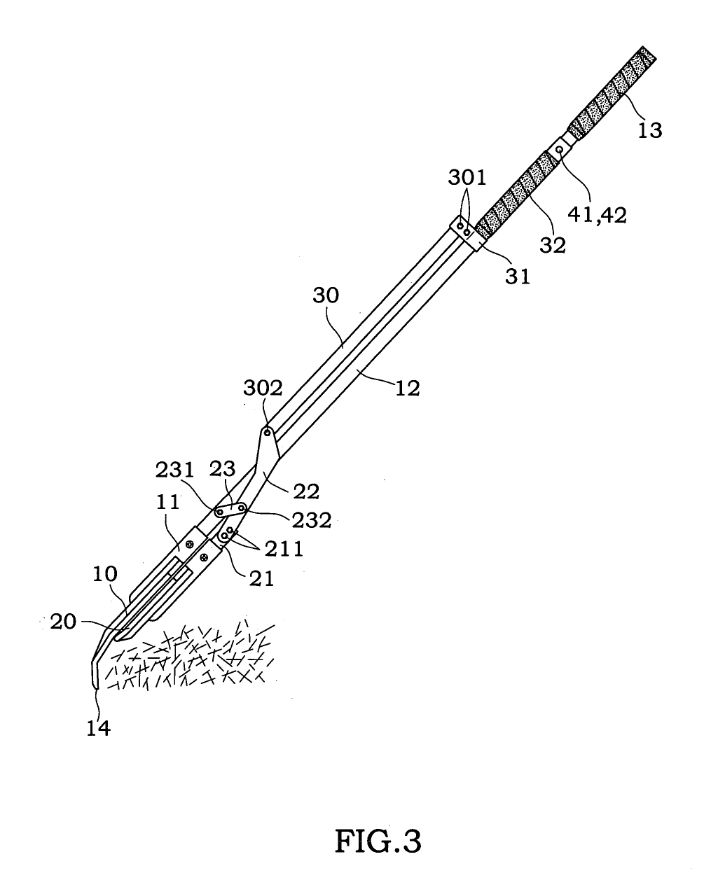

In FIG. 3, when the sliding sheath 32 is pulled towards the handle 13 to snap the spring pip 41 into the pip hole 42, the pushing rod 30 will be pulled upward, so that the pivotal link rod 22 uses a link plate 23 as the pivotal center to swing an end connected with the pushing rod 30 away from the rake plate 10. The clamping plate 20 connected to another end of the pivotal link rod 22 will swing towards the rake plate 10 and be engaged with the rake plate 10. When the rake plate 10 and the clamping plate 20 are fully attached, the tines 14 of the rake plate are protruded from the edge of the clamping plate 20 to facilitate the tines 14 to rake the grass and leaf debris into a pile. Such arrangement also facilitates the storage of the rake, because the pushing rod 30 is set into a fixed position by the spring pip 41, and has no risk of sliding down, and also prevents the stored rake from being opened.

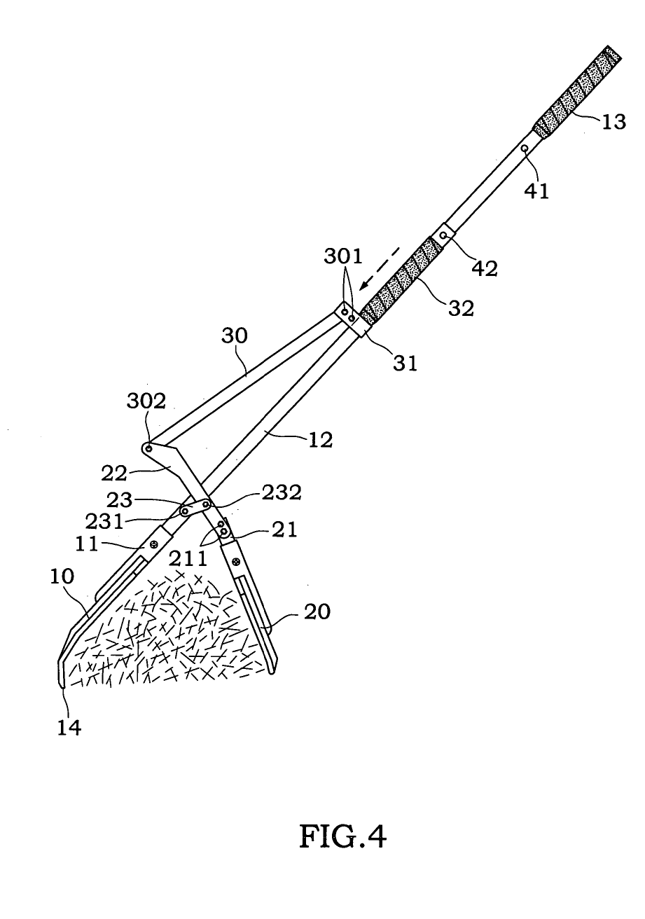

In FIG. 4, when users release the fixed positions of the handle rod 12 and the sliding sheath 32 and push the sliding sheath 32 along the arrowed direction as shown in the figure, the pivotal link rod 22 uses the link plate 23 as a fulcrum to swing an end connected to the pushing rod 30 towards the rake plate 10, and the clamping plate 20 at the other end swings in the direction away from the rake plate 10, and thus opening up the space between the rake plate 10 and the clamping plate 20. The lower the pushing rod pushes, the larger is the included angle between the rake plate 10 and the clamping plate 20, and vice versa. The space between the rake plate 10 and the clamping plate 20 is opened up until the rake is spread into an appropriate angle to facilitate raking and picking up the grass and leaf debris.

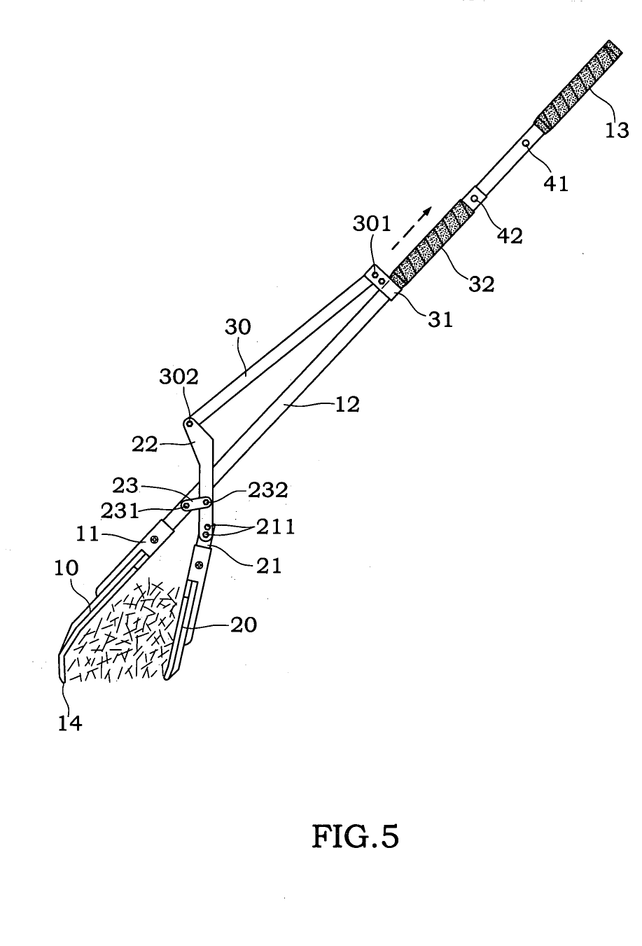

In FIG. 5, when the space between the rake plate 10 and the clamping plate 20 is increased to an appropriate extent and large enough to rake a predetermined pile of the grass and leaf debris, users can pull the sliding sheath 32 up along the arrowed direction to engage the rake plate 10 with the clamping plate 20 to pick up the grass and leaf debris and dump them at a predetermined location.

The rake of the invention can rake the grass and leaf debris into a pile, and also can pick up and dump the pile of debris. Raking the leaves and picking up the leaves are done by the rake with a single continuous action, so that the gardener no longer needs to change tools frequently during the clean-up process, and thus improving the working efficiency and saving physical strength.

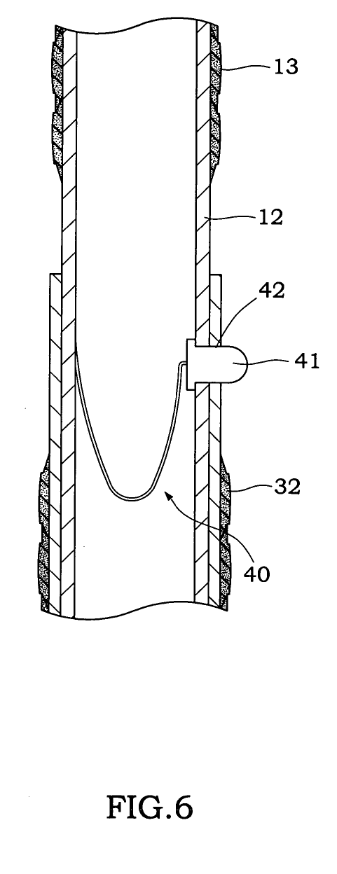

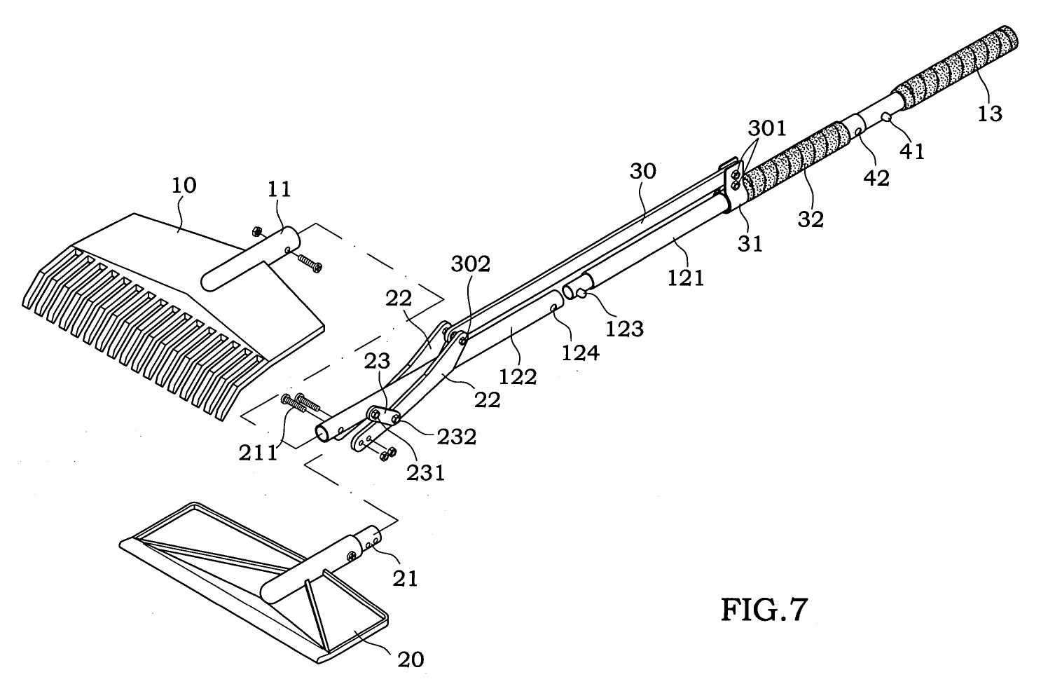

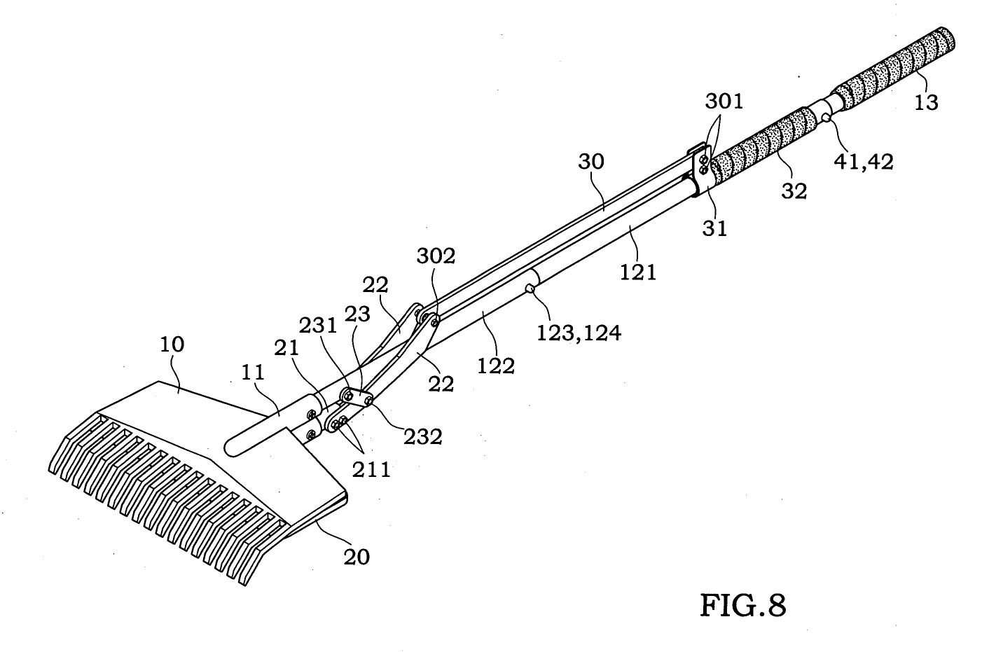

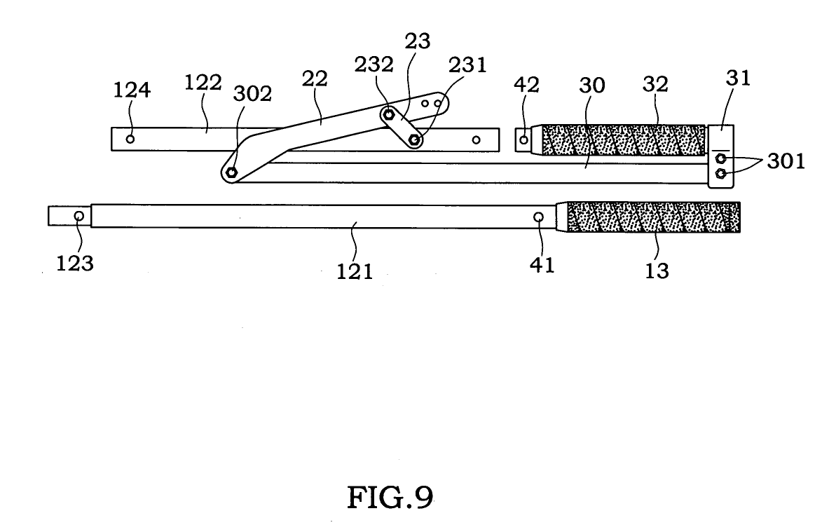

Please refer to FIGS. 7, 8, and 9 for a second preferred embodiment of the present invention. The difference between the second preferred embodiment with the first preferred embodiment resides on that the handle rod 12 is divided into two sections (a first rod section 121 and a second rod section 122) for facilitating the removal of the rod body of the rake and reducing the packaging space. The first rod section 121 according to the second preferred embodiment adopts the technology as depicted in FIG. 6 comprises a spring pip 123 protruded from the rod wall at one end of the handle rod 12, and a corresponding pip hole 124 disposed at an end of the second rod section 122, so that when the first and second rod sections are combined, the spring pip 123 is snapped into the pip hole 124. On the other hand, the spring pip 123 is pressed and the second rod section 122 is pulled away from the first rod section 121 to detach the first and second rod sections 121, 122. The separation of the first and second rod sections isolates the sliding sheath 32, and then the pivotal link rod 22 and the link plates 23 are used to push the second rod section 122 and the pushing rod 30 together. The separated first rod section 121 can be put next to the second rod section 122 to fold the rod body of the rake as shown in FIG. 9, and thus reducing the volume and saving the cost for its package and transportation.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. (canceled)

2. (canceled)

3. (canceled)

4. The rake assembly with pickup function of claim 10, further comprising at least one link plate pivotally coupled between said handle rod and said pivotal link rod.

5. The rake assembly with pickup function of claim 10, wherein said handle rod has a handle at one end.

6. The rake assembly with pickup function of claim 5, wherein said handle is wrapped with a soft elastic tape.

7. The rake assembly with pickup function of claim 10, wherein said sliding sheath is wrapped with a soft elastic tape.

8. The rake assembly with pickup function of claim 10, wherein said handle rod comprises a first rod section and a second rod section, and one end of said second rod section is coupled with a handle, and the open ends of said first and second rod sections are serially coupled with each other.

9. The rake assembly with pickup function of claim 8, wherein said first rod section at one end has a spring pip protruded from a rod wall, and said second rod section at a corresponding end has a pip hole disposed on a rod wall, such that when said first and second rod sections are serially coupled, said spring pip is snapped into said pip hole.

10. A rake assembly with pickup function, comprising:
a handle rod,
a rake plate, having a first end, a center portion on said first end, a second end and a plurality of tines on said second end, and with said rake plate being coupled with said handle rod at said center portion of said first end;
a pair of pivotal link rods each having a new body;
a clamping plate, having a central portion on a first end coupled to at least one of said pivotal link rods, with said handle rod being pivotally coupled with said rod body of said pivotal link rods;
a sliding sheath;
a pushing rod, having a first end pivotally coupled to an edge of said sliding sheath, and with said sliding sheath being sheathed onto said handle rod, and said second end of said pushing rod being movably coupled with an end of at least one of said pivotal link rods, and with said rod body of said handle rod disposed between said pair of pivotal link rods, and movably coupled with said pair of pivotal link rods.
